(19) United States
(12) Patent Application Publication
(10) Pub. No.: US 2024/0361634 A1
(43) Pub. Date: Oct. 31, 2024

(54) HYBRID BACKLIGHTING FOR DISPLAY SCREENS

(71) Applicant: Peter Veto, Budapest (HU)

(72) Inventor: Peter Veto, Budapest (HU)

(21) Appl. No.: 18/645,154

(22) Filed: Apr. 24, 2024

Related U.S. Application Data
(60) Provisional application No. 63/461,669, filed on Apr. 25, 2023.

(51) Int. Cl. G02F 1/13357; G09G 3/34

(52) U.S. Cl. CPC G02F 1/1336; G09G 3/3406; G09G 2360/144

(57) ABSTRACT

Disclosed herein is an apparatus and method for hybrid backlighting of display screens. The apparatus comprises an external light unit and an internal light unit, both configured to illuminate the display screen using light from external and internal light sources, respectively. A secondary optical element within the apparatus ensures efficient and homogeneous light distribution across the display screen. The external light unit features a port adaptable to various light delivery systems, such as solar light collectors or electric light sources. A dimmer element and a sensor enable control and measurement of light intensity and spectral composition. The method involves obtaining light data from external sources, determining a hybrid lighting configuration, and adjusting filtering and light configurations accordingly. Dynamic adjustments based on user settings and environmental parameters enhance user experience, with the hybrid lighting configuration tailored to individual preferences for visual or physiological effects of light exposure.

### CROSS-REFERENCE TO RELATED APPLICATIONS

This application claims priority under 35 USC 119(a) (1) of Provisional Application: 63/461,669, filed on Apr. 25, 2023.

### BACKGROUND OF THE INVENTION

Backlit displays have been used with various backlight sources, like fluorescent or light emitting diode (LED) sources. However, digital eye strain and various negative health effects of digital display use are increasingly problematic, despite continued progress in screen visual quality. An object of the present invention is to provide an improved backlighting system, capable of display illumination using a multitude of light sources including sunlight through an external solar light collector device or electric light sources.

As our understanding of the profound physiological effects of light across different wavelengths grows, it becomes evident that the visual aspects of light do not necessarily correlate closely with its impact on health. Therefore, the limited spectral range and imbalanced light composition of the light emitted by regular computer displays also pose limitations on any effort to mitigate the negative health consequences of our ever increasing screen-time durations.

Moreover, the dilemma between prioritizing health and energy efficiency in general lighting finds a solution in daylighting. Utilizing windows or light tunnels, this approach provides cost-effective and health-conscious illumination without relying on electricity consumption. Such a solution has so far not existed for digital displays. While some front-lit display technologies offer the potential for using daylight, inherent technical limitations restrict their broader adoption. These displays primarily appeal to a niche of light-sensitive users due to their health benefits under daylight illumination. However, usability limitations and low image quality prevent them from replacing standard self-luminous displays.

### SUMMARY OF THE INVENTION

Present invention is a backlighting apparatus and method for hybrid illumination of a display screen. The invention makes it possible to illuminate a display with an internal light source, an external light source, or any combination thereof.

The invention has multiple embodiments. The schematic depictions in the accompanying drawings represent an embodiment of the invention. While the drawings are based on a functional prototype, they illustrate the invention in a generalized and simplified manner.

The invention addresses several limitations of existing computer screens by offering versatile solutions. Through options like utilizing a solar light collector device for fiber optic daylighting as one mode of application for the external light source, the invention minimizes energy consumption while ensuring optimal and health-conscious illumination. Further flexibility of use is offered by the possibility of utilizing any external light source for backlighting, including therapeutic light sources within or beyond the visible range of light. Through the internal electric light source, stand-alone operation of the display is still possible, along with supplementation of backlighting when light intensity from an external light source is insufficient.

Different digital displays have different spectral filtering properties. These properties, together with the invention's internal capabilities of adjusting light spectrum and intensity from the internal and external sources, also allow for customization of light emission from a digital screen device.

### BRIEF DESCRIPTION OF DRAWINGS

FIG. 1 depicts the general arrangement of one embodiment of the hybrid backlighting apparatus of the present invention.

FIG. 2 depicts the external light unit of FIG. 1.

FIG. 3 depicts the internal light unit of FIG. 1.

FIG. 4 is a block diagram of the elements of an exemplary hybrid backlighting apparatus according to the disclosure.

FIG. 5 is a flow diagram of an exemplary method of hybrid backlighting for display screens according to the disclosure.

### DETAILED DESCRIPTION OF THE INVENTION

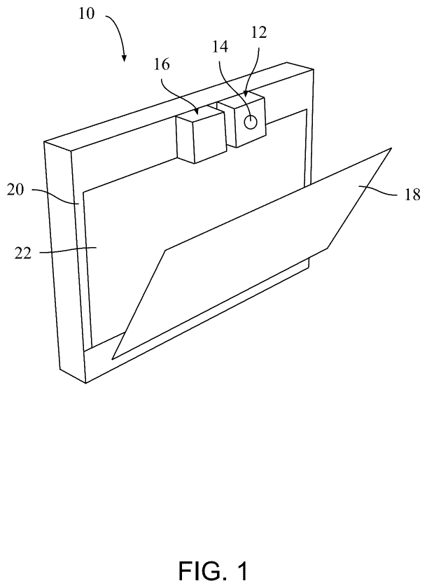

FIG. 1 depicts a top-side-rear view of one embodiment 10 of the invention. The embodiment has an external light unit 12 containing a port 14, an internal light unit 16, a secondary optical element 18, a display housing member 20, and a display 22.

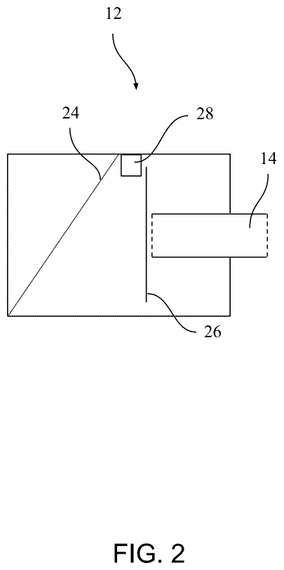

FIG. 2 depicts a side view cross-section of one embodiment of the external light unit 12. The external light unit contains the port 14 and has a primary optical element for external light sources (OELEXT) 24.

The port 14 is an opening towards the outside of the apparatus configured to connect to the end of an optical fiber cable, such as that of a solar light collector device or other optical fiber illuminator, or to an external light source, such as an LED or other electric light source. In one embodiment, the port is a cylindrical opening normal to the rear side of the display assembly. In other embodiments, the port may take any of a number of suitable shapes and orientations.

In one embodiment, OELEXT 24 is a reflective surface configured to reflect light from the port to the secondary optical element 18. In other embodiments, OELEXT may be a refractive optical element. OELEXT may additionally have light filtering or light polarizing material properties.

The external light unit may also comprise a dimmer element 26 configured to attenuate light intensity from the port. In one embodiment, the dimmer element is a linear variable neutral density filter with an adjustable displacement mechanism. In another embodiment, the dimmer element is a circular linear variable neutral density filter with an adjustable rotation mechanism. In a further embodiment, the dimmer element is an adjustable aperture diaphragm. In a still further embodiment, the dimmer element is a solid-state tunable filter. In various embodiments, the dimmer element may include any of a number of suitable variable optical attenuator mechanisms. The dimmer element may have constant or adjustable light filtering properties affecting light intensity, light spectral composition, or a combination thereof.

The external light unit may further comprise a sensor 28. In one embodiment, the sensor is a photodiode designed to measure light intensity. In another embodiment, the sensor is a spectrometer designed to measure light spectral composition. In various embodiments, the sensor may include any of a number of suitable mechanisms of light intensity and light spectral composition measurement or any combination thereof. Information from the sensor can be used to regulate the backlight intensity, spectral composition, or both.

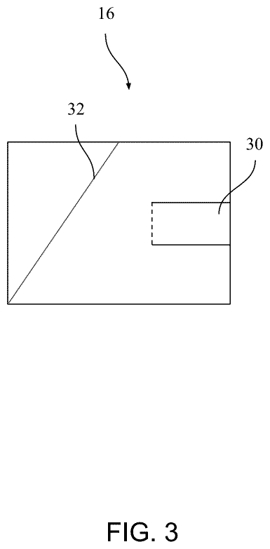

FIG. 3 depicts a side view cross-section of one embodiment of the internal light unit 16. The internal light unit contains an internal light source 30 and a primary optical element for internal light sources (OELINT) 32.

The internal light source 30 is configured to provide backlight illumination for the display 22. In one embodiment, the internal light source is an LED light engine containing a single LED or a plurality of LEDs. In other embodiments, the internal light source is any of a number of suitable electric light sources, such as, but not limited to, incandescent, organic LED, fluorescent, metal halide, or laser light sources. The internal light source may further comprise refractive, reflective, or luminescent optical elements.

In one embodiment, OELINT 32 is a reflective surface configured to reflect light from the internal light source to the secondary optical element 18. In other embodiments, OELINT may be a refractive optical element. OELINT may additionally have light filtering or light polarizing material properties.

OELEXT 24 and OELINT 32 share similar functionality within the external light unit 12 and internal light unit 16, respectively. However, the designs of OELEXT and OELINT may differ due to the varying spatial or spectral properties of the light they handle: OELEXT functions with light entering through the port 14 from an external light source, while OELINT operates with light from the internal light source 30.

The secondary optical element 18 is a reflective surface configured to reflect light from both the external light unit 12 and the internal light unit 16 to the display 22. In one embodiment, the secondary optical element has a freeform shape configured for optimal efficiency and homogeneous light intensity distribution across the rear surface of the display. In some embodiments, the secondary optical element may enclose the space defined by the external light unit 12, the internal light unit 16, the secondary optical element 18, as well as the rear sides of the display housing member 20 and the display 22. The secondary optical element may have additional light filtering, light polarizing, or photoluminescent properties. Between various embodiments, the contribution of the secondary optical element to the light intensity distribution on the display may diverge.

The display housing member 20 has a cavity adapted to receive the display 22. In one embodiment, the display is a liquid crystal display (LCD). In other embodiments, the display can be any type of display, including but not limited to single display panels, binocular display systems, video walls, or tiled displays.

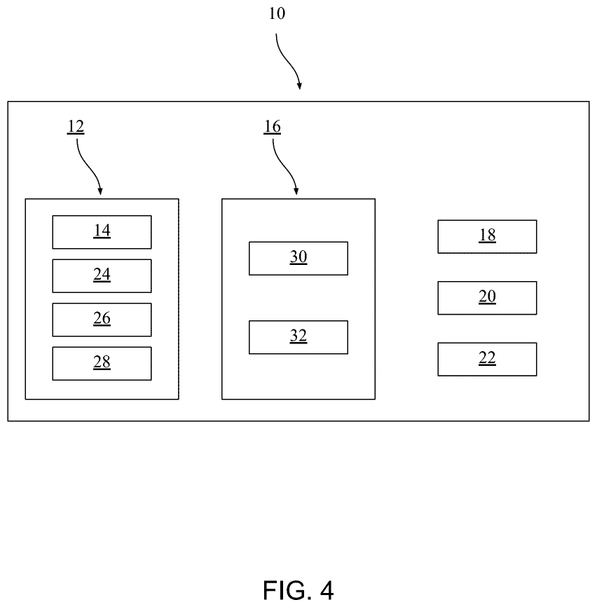

FIG. 4 provides an overview of the elements of one embodiment 10 of the invention, as depicted in more spatial detail in FIGS. 1-3.

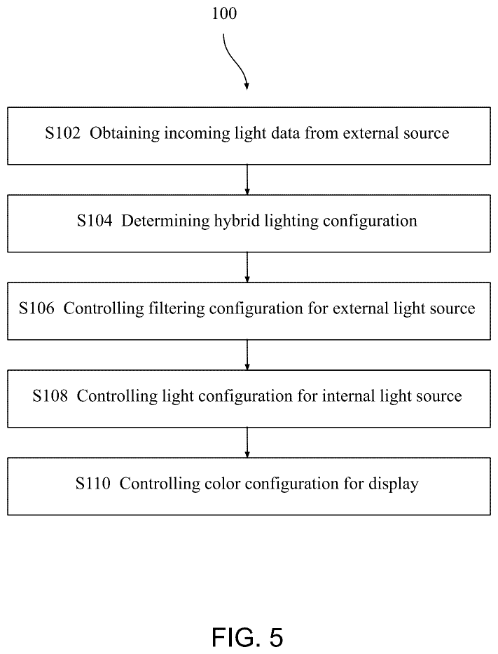

FIG. 5 depicts an example method 100. The display backlighting apparatus of invention 10 can operate on an internal or an external light source or any combination thereof. Such hybrid operation is possible according to any rigid setting or according to dynamic adjustments by a user or external system. However, in some embodiments, hybrid operation may also take effect according to the method 100, comprising the following steps:

In S102, light data from an external light source are obtained. In some implementations, such light data may be retrieved from the sensor 28. In other implementations, light data may originate from an external measurement. Light data may include measurements of light intensity, spectral composition, or both. Light data may extend beyond the limits of the visible range of light.

In S104, a hybrid lighting configuration is determined based on the light data obtained in S102. It may also include other pieces of information, such as, but not limited to, user settings, user health needs as determined by a health application, measurements of ambient light levels, geographical location, date, time of day, or weather parameters. The hybrid lighting configuration may also be dependent on user profiles or user setting preferences with emphasis or one or another health aspect of the physiological effects of light exposure.

In S106, a filtering configuration for the external light unit is determined. Here, light intensity from an external light source may be attenuated or light spectral composition from an external light source may be altered, as described for the dimmer element 26.

In S108, a light configuration for the internal light source 30 is determined. Dependent on steps S102-S106, light output from the internal light source may be modified in intensity or spectral composition or both, so that a desired light output to the display 22 is achieved with light output from the internal light unit 16, the external light unit 12, or a combination thereof.

In S110, a color configuration for the display 22 is determined. Light output to the user is dependent on light output to the display and the light filtering properties of the display. To this end, in some implementations of the method 100, color settings of the display may also be altered.

1. An apparatus for hybrid backlighting of a display screen, comprising: an external light unit configured to illuminate the display screen with light from an external light source; an internal light unit configured to illuminate the display screen with light from an internal light source; and a display housing member adapted to receive the display screen; wherein, the apparatus is capable of illuminating the display screen using an external light source, the internal light source, or a combination thereof.

2. The apparatus of claim 1, wherein the external light unit comprises a port configured to receive light from an external light source, said port being capable of connecting to various light delivery systems including optical fiber cables, solar light collector devices, electric light sources, or other external light sources.

3. The apparatus of claim 1, wherein the internal light source comprises one or more light emitting elements chosen from the group consisting of incandescent light sources, light emitting diodes, organic light emitting diodes, and other suitable electric light sources.

4. The apparatus of claim 1, having a secondary optical element configured to project light from both the external light unit and the internal light unit towards the display screen.

5. The apparatus of claim 1, wherein the secondary optical element has a freeform shape for optimal efficiency and homogeneous light intensity distribution across the display screen.

6. The apparatus of claim 1, further comprising a dimmer element within the external light unit for adjusting light intensity, spectral composition, or both.

7. The apparatus of claim 1, further comprising a sensor within the external light unit for measuring light intensity, spectral composition, or both.

8. The apparatus of claim 1, wherein the display can be configured in various configurations, including but not limited to single display panels, binocular display systems, video walls, or tiled displays.

9. A method for hybrid backlighting of a display screen, comprising the steps of: obtaining incoming light data from an external light source; determining a hybrid lighting configuration; controlling filtering configuration for the external light source; and controlling light configuration for the internal light source based on the hybrid lighting configuration.

10. The method of claim 9, further comprising obtaining light data from the sensor.

11. The method of claim 9, wherein a filtering configuration for the display screen may also be controlled to optimize spectral output to user needs.

12. The method of claim 9, further comprising adjusting the hybrid lighting configuration dynamically based on user settings, environmental parameters, or both.

13. The method of claim 9, wherein the hybrid lighting configuration is determined based on user profiles or preferences regarding visual or physiological effects of light exposure.
